(19) United States
(12) Patent Application Publication
(10) Pub. No.: US 2009/0151876 A1
(43) Pub. Date: Jun. 18, 2009

(54) Apparatus for Securing a Tire to a Wheel

(76) Inventor: Scott W. Rider, Lawson, MO (US)

Correspondence Address: POLSINELLI SHUGHART PC, 700 West 47th Street, Suite 1000, KANSAS CITY, MO, 64112, US

(21) Appl. No.: 11/957,397

(22) Filed: Dec. 14, 2007

(51) Int. Cl. B60C 25/04

(52) U.S. Cl. 157/1.33

(57) ABSTRACT

An apparatus for securing a tire bead of a tire to a wheel is disclosure. The apparatus utilizes tire bead clamping structure to secure a the tire bead of a tire to the mounting flange of the wheel. The tire bead mounting flange contains a circumferential protrusion that extends axially outward from the fire bead mounting and makes contact with the tire bead. The removable, tire bead clamping ring makes contact with the opposite side of the tire bead and is secured to the wheel utilizing removable fasteners.

### FIELD OF THE INVENTION

The present invention relates to a tire and a wheel. More specifically, the invention provides a method and apparatus for securing a tire to a wheel for use in high rotational speed and torque wheel applications. Furthermore, the wheel utilizes at least one and more typically, a pair of sealing rings that assists in maintaining the location of a tire with respect to the outer and inner rim of a wheel. Mechanical fasteners are used to secure the sealing ring or rings to the rim of the wheel. Wheels utilizing the sealing rings may be structured as multiple component wheels. These types of wheel applications are often used in high performance applications such as drag and sprint car racing and other high torque applications such as on weight pulling vehicles and other similar applications

### BACKGROUND OF THE INVENTION

High torque and high speed applications such as drag racing or sprint car racing require special wheels to ensure that the tire maintains its location on the rim. Conventional wheels and typical tubeless tires form a seal commonly called a bead along the rim outer rim and the inner rim of the wheel. Breaking of this seal or bead will cause the air to leak from the tire resulting in a flat tire with tubeless tires. In high wheel speed and torque applications, the wheel, which is rotatively connected to the drive shaft of the vehicle engine may result in high rotational speed with large down force. When a wheel-tire combination experiences high rotational speed with low down force of the wheel-tire, the tire may not grip the surface and the wheel spins. Conversely, if the wheel-tire combination experience high rotational speeds and high down force, the wheel may rotate at a higher speed than the tire which is being driven into the surface due to the high down force. As such, the bead or seal of the wheel-tire combination may be broken resulting in the tire coming off of the wheel. Even tires which utilize a tube, often fail when the tire separates from the rim. The tube is easily cut if it becomes of the wheel These failures often result in damage to the vehicle as well as damage to surround structures or bystanders. These types of conditions are often experienced in vehicle racing applications such as drag racing, sprint and midget racing and other dirt racing applications.

To prevent the tire from separating from the rim and breaking the bead or seal, users have utilize mechanical fasteners, screws, to secure the tire at the rim to the wheel. Small holes are drilled in the wheel rim before the tire is mounted. Once mounted and filled with air, small mechanical fasteners are placed in the drilled holes which have a slightly smaller diameter than the mechanical fasteners, and screwed through the rim into the material of the tire called the bead bundle of the tire. The process is repeated on the opposite side of the wheel-tire combination. This process is typically used with wheels composed of softer materials such as aluminum or magnesium alloys or a multiple component wheel may be constructed of steel, titanium and utilize an aluminum or magnesium at the rim area of the wheel.

The use of wheel screws satisfies many high wheel speed and high torque applications. However, there are typically not appropriate for long use applications such as a multiple lap race. It is common for tires that are screwed on the rim to slowly leak air at a screw. In some applications such as drag racing, a slow leak is not an issue due to the fact that the races are over a short distance lasting only seconds.

The wheel screws may affect the characteristics of the sidewall of the tire. The sidewall of the tire, especially “slicks” used in drag racing applications where the sidewall of the tire is relatively large. The sidewall characteristics can effect how the tire compresses downward at the initial hit of power to the drive wheels. The first movement of the drive wheel along with the flexibility of the vehicle chassis drives the wheel downward towards the pavement and the sidewall flexes. If the tire remains in contact with the payment and does not spin, the wheel turns and the tire “wraps” with the rotation of the wheel while the area of the tire that is in contact with the pavement remains planted to the pavement surface. In many cases the wheel screws will prevent the tire from separating from the wheel under these conditions. However, in some applications with high torque and wheel speeds the wheel screws may not keep the tire on the wheel. Likewise, a slow leak cause by a tire screw can be disastrous in applications where the vehicle undergoes multiple laps. These applications require another method or device to maintain the seal of the tire to the wheel.

An alternative method for securing the tire to a wheel that undergoes high torque and high wheel speeds, is the use of bead locks. A bead lock is a ring that is used to hold the tire to the wheel rim. The bead bundle of the tire is sandwiched between the bead lock ring and the wheel rim. Mechanical fasteners are then used to hold the bead lock to the bead lock to rim of the wheel. Bead locks are commonly used in racing on application such as drag racing top fuel cars to sprint cars and midgets. They are also used in other forms of dirt and off-road racing and application where wheel screws are inadequate to hold the tire to the rim.

The clamping rings of a bead lock style wheel are typically designed as a mirror image of the rim of the wheel and are typically used on both sides of the wheel. One common design is shaped such that when the wheel rim and positioned together, they form a channel between the rim and bead lock for receiving the bead bundle portion of the tire. Surface of the formed channel is smooth and the walls, on the clamping ring and the second on the flange of the wheel rim. Mechanical fasteners are then treaded through the clamping ring of the bead lock and into a flange area of the wheel rim. Unlike wheel screws, the mechanical fasteners of the bead lock system do not travel through the bead bundle portion the tire. This type of bead lock system provides a more even clamping of the tire to the wheel rim to prevent breaking of the tire seal or bead.

Mounting a tire on a wheel that utilizes the bead lock system is often difficult. With the clamping rings removed and the tire positioned on its side, the wheel is inserted into the tire. The bead must be positioned on the flange area of the rim of the wheel. A flat blade screw driver or small putty knife is often needed to work the bead bundle portion on to the rim flange. The clamping ring is then placed on the bead of the tire. Mechanical fasteners or bolts are then hand-threaded through the clamp into the wheel rim at the 12, 6, 3 and 9 o'clock position. Caution must be taken to prevent the tire bead from falling off the rim flange. Once complete, the remainder of the bolts are started by hand. Each bolt must be tightened using a ratchet, but only a few turns at a time before moving to the next bolt to prevent the clamping ring from flexing which results in unequal clamping force. A torque wrench is used to ensure each bolt is torqued to the same amount in accordance with the manufacturer's instructions. Unevenly torqued bolts will result in distortion of the clamping ring which shortens the life of the clamping ring and may result in loss of the seal when under operating conditions.

Although the conventional bead lock wheel system provides advantages over wheel screws, these systems still may fail. Improper installation at the bead bundle or unequal torquing forces may lead to failures. Further, the conventional bead lock systems are difficult to install. Therefore, there is a need for an easier to install bead lock system and one that provides greater grip strengths and gripping properties.

### SUMMARY OF THE INVENTION

In accordance with these and other objects evident from the following description of the preferred embodiments, the embodiments provide an apparatus for securing a tire on a wheel. The present system utilizes a tire bead clamping structure to secure the bead of a tire to the a wheel at the tire bead mounting flange of the wheel. The removable, tire bead clamping ring makes contact with the opposite side of the tire bead and thereby, sandwiching the wheel, tire and clamping ring and the claiming ring is secured to the wheel utilizing removable fasteners.

One embodiment utilizes a circumferential protrusion sealing ring on the mounting flange of the wheel rim which establishes an additional gripping surface and pressure on the bead portion of the tire.

A second embodiment uses a circumferential bead lock wedge which assists with installation and provides greater gripping and sealing properties. A third embodiment utilizes a circumferential bead relief groove extending axially inward of the wheel and positioned radially inwardly of the circumferential protrusion. A fourth embodiment utilizes scalloped sealing ring and wheel rim flange to increase the claiming strength of the bead lock wheel system. A fifth embodiment utilizes a combination of improvements including a circumferential protrusion on the flange of the wheel rim, bead relief groove, circumferential bead lock wedge and scalloped sealing ring. Additional various aspects of the individual embodiments may be combined to secure a tire to the wheel utilizing a bead clamping ring.

Other aspects and advantages of the present invention will be apparent from the following detailed description of the preferred embodiments and the accompanying drawing figures. The drawings constitute a part of this specification, include exemplary embodiments of the apparatus for securing a tire to a wheel, and illustrate various objects and features thereof.

### BRIEF DESCRIPTION OF THE DRAWINGS

FIG. 1 is an isometric cross sectional view of a conventional bead lock wheel system with the clamping ring installed;

FIG. 2 is an isometric close-up cross-sectional view of a conventional bead lock wheel system with the clamping ring installed;

FIG. 3 is a an isometric close-up cross-sectional view of a conventional bead lock wheel system without the clamping ring installed.

FIG. 4 is an axial cross-sectional view of a conventional bead lock system showing an installed clamping ring at a flange of the wheel rim.

FIG. 5 is an isometric cross-sectional view of an improved bead lock wheel system with an improved tire bead clamping ring;

FIG. 6 is a portion of an isometric cross-sectional view of an improved bead lock wheel system with the bead clamping installed showing the circumferential protrusion, bead relief, groove and bead lock wedge;

FIG. 7 is a portion of an isometric cross-sectional view of an improved bead lock wheel system without the bead clamping ring illustrating the circumferential protrusion on the flange of the wheel rim;

FIG. 8 is a portion cross-sectional view of improved bead lock wheel system illustrating the flange of the wheel rim and bead clamping ring and circumferential protrusion and bead lock wedge;

FIG. 9 is a portion of the bead lock wheel system showing bead clamping and the bead lock wedge; and

FIG. 10 is an isometric view of an improved bead lock wheel system having an inner diameter scalloped wheel flange and a circumferentially double scalloped bead mounting sealing ring.

### DESCRIPTION OF THE PREFERRED EMBODIMENT

As required, detailed embodiments of the apparatus of securing a tire to a wheel are disclosed herein; however, it is to be understood that the disclosed embodiments are merely exemplary of the device, which may be embodied in various forms. Therefore, specific structural and functional details disclosed herein are not to be interpreted as limiting, but merely as a basis for the claims and as a representative basis for teaching one skilled in the art to variously employ the apparatus in virtually any appropriately detailed structure.

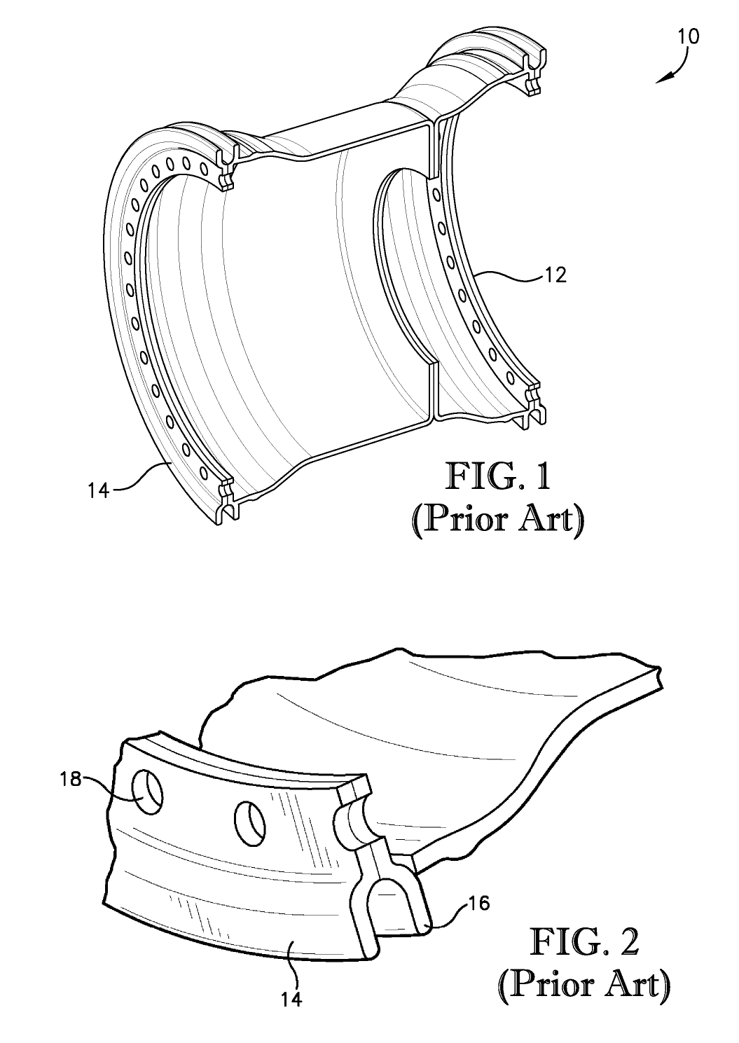

Prior art or conventional bead lock wheel systems 10 are shown in FIGS. 1 through 4. These systems and wheels are typically composed of high strength materials such as steel, titanium, magnesium and alloys thereof. Wheels are typically machined but may be forged or cast with finishing machining. These wheel systems are typically utilized with rubber, natural, synthetic or combinations thereof tires. As shown in FIGS. 1 and 2, these conventional bead lock wheel systems 2, utilize a wheel 12 and a conventional tire bead clamping ring 14 which is secured to wheel 12 by mechanical fasteners (not shown) which pass through fastener receiving holes 18. FIGS. 2 and 4 illustrate a cross-sectional view of conventional bead lock wheel system 10 with conventional tire bead clamping ring 14 positioned on wheel 12.

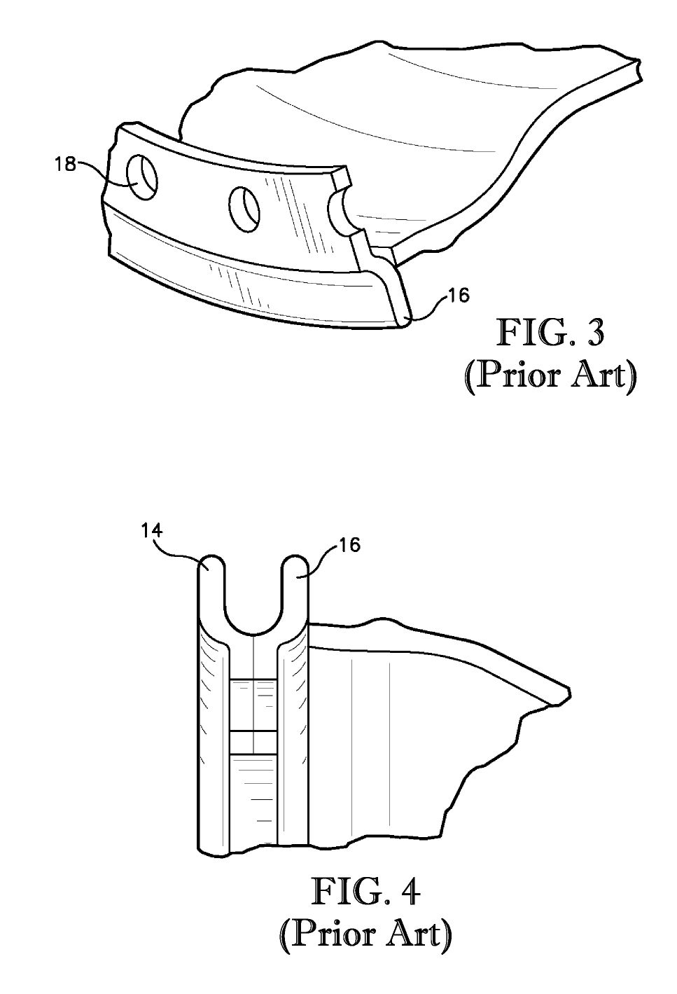

As shown in FIG. 3, wheel 12 contains conventional tire bead mounting flange 16 which has a smooth surface and further a curved shoulder. The bead of a tire (not shown) is positioned on conventional tire bead mounting flange 16 with the end of the bead fitting in the curved shoulder. Conventional tire bead clamping ring 14 as shown in FIGS. 2 and 4 has a shape that is typically a mirror image of conventional tire bead mounting flange 16 and forms a “U” shaped channel when mated to wheel 12. The bead of the tire (not shown) is contained in the “U” shaped channel and held in place when fasteners inserted and tightened in fastener receiving holes 18.

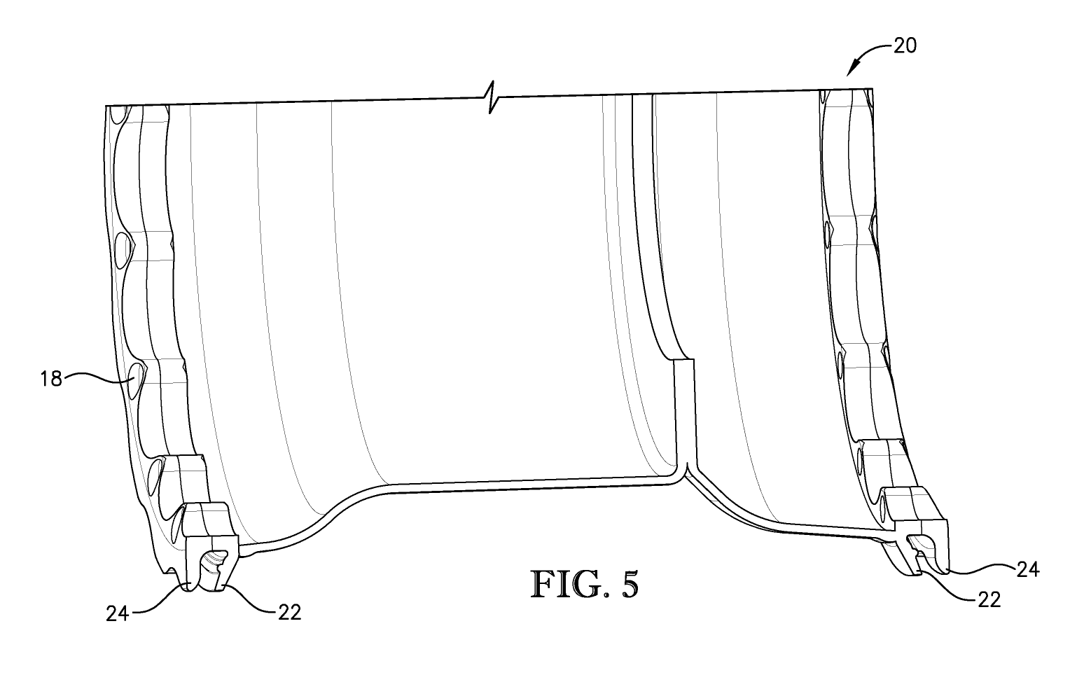

Turning to FIG. 5, an improved tire bead clamping structure and wheel 20 is shown. Wheel 12 contains an improved tire bead mounting flange 22 which may have various features and combinations of improvements. Improved bead clamping structure and wheel 20 also utilizes an improved tire bead clamping ring 24 which fastener receiving holes 18 and fasteners (not shown) to sandwich the tire bead between improved tire bead clamping ring 24 and improved tire bead mounting flange 22. Further, improved tire bead clamping ring 24 may be circumferentially scalloped which are directed radially inward. This configuration may provide greater clamping forces at the fastener receiving holes 18.

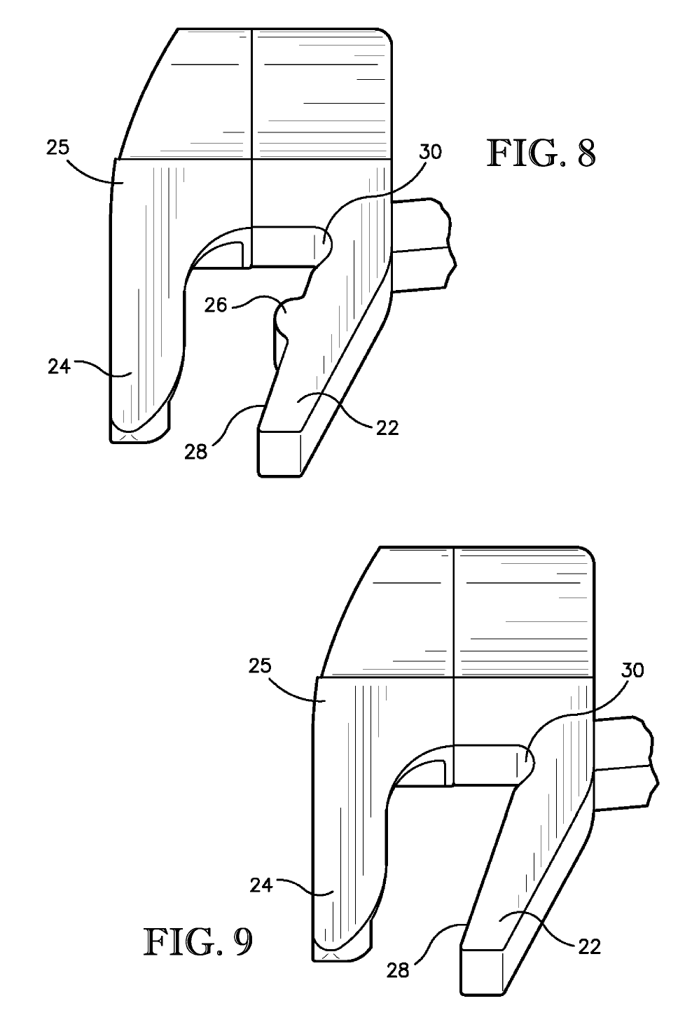

FIGS. 8 and 9 is a portion of a cross sectional view improved tire bead clamping ring 24 mated to the tire bead mounting flange 22. Improved tire bead clamping ring 24 utilizes a circumferential bead lock base which is not present on conventional tire bead clamping ring 14 shown in FIG. 4. This base increases the mass of material in which fastener receiving holes 18 are through. This may provide greater clamping forces and reduces the risk of deformation of tire bead clamping ring 24 as the fasteners are tightened.

Improved tire bead mounting flange 22 is also shown in FIGS. 8 and 9. FIG. 8 illustrates a circumferential protrusion 26 which extends axially outward from improved tire bead mounting flange 22. When improved tire bead clamping ring 24 is mounted to improved tire bead mounting flange 24, circumferential protrusion 26 deforms the tire bead and increases the grip of the tire bead and increases the surface contact area of the tire bead over conventional tire bead mounting flange 16. Improved tire bead mounting flange 22 further contains a circumferential bead lock wedge contact surface 28 which extends circumferentially along the surface of improved tire bead mounting flange 22. Differences between circumferential bead lock wedge contact surface 28 can be seen when by comparing FIGS. 8 and 9 with conventional tire bead mounting flange 16 shown in FIG. 4. Circumferential bead lock wedge contact surface 28 is angled inward to create a “wedge shape.” This increases the grip of the improved tire bead clamping structure and wheel 20. Circumferential bead lock wedge contact surface 28 may utilize a range of angles which may be varied for optimal gripping and to accommodate various stiffness of the tire bead material. These angles could range from 10 to 89 degrees depending upon tire materials and the thickness of the tire bead.

To further increase the grip of improved tire bead clamping structure and wheel 20, a circumferential bead relief groove 30 is included on improved tire bead mounting flange 22. circumferential bead relief groove 30 extends axially inward of wheel 12. FIG. 9 illustrates an alternative embodiment of improved tire bead mounting flange 22 which does not utilize circumferential protrusion 26.

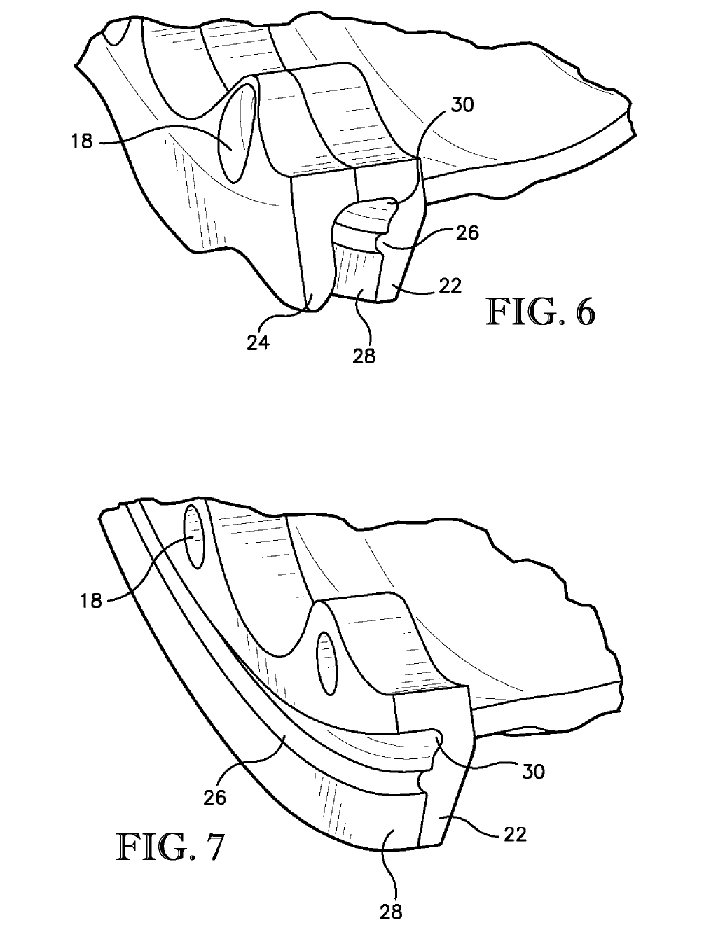

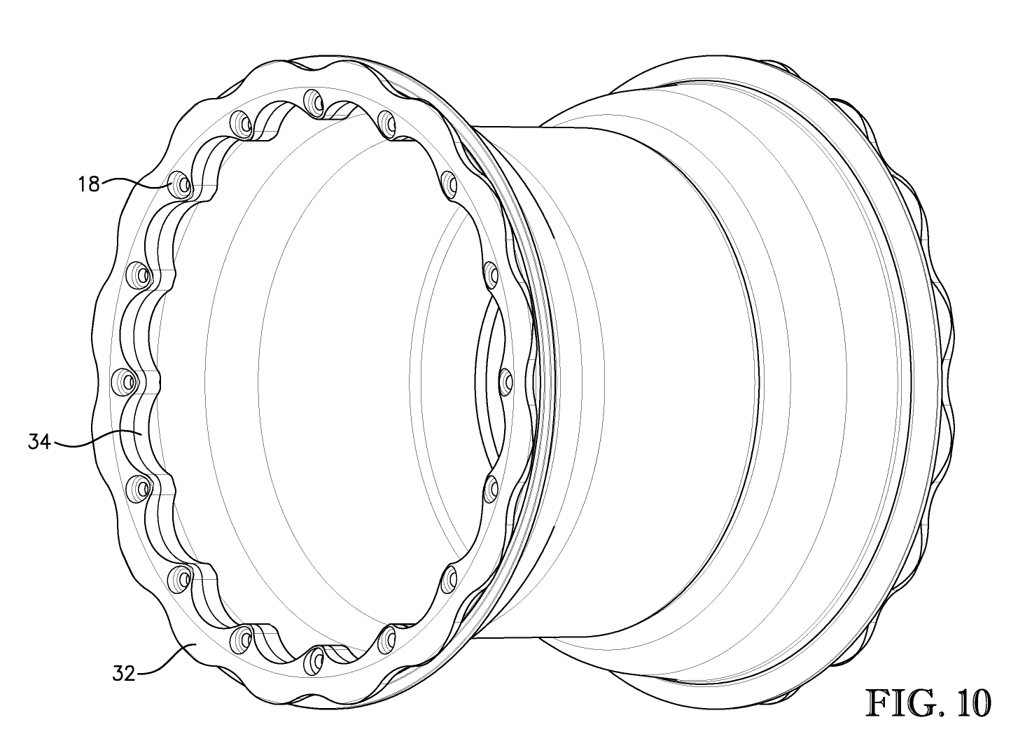

FIG. 10 along with FIGS. 5 through 7 illustrate another embodiment of the improved bead clamping structure and wheel 20 which may utilized with or without the improved tire bead mounting flange 22. Improved tire bead clamping ring 24 may utilize scalloped designed. As shown in FIG. 10, improved tire bead mounting flange 22 utilizes circumferentially spaced base scallops 34 formed radially into the inner bead lock circumference. The corresponding improved tire bead clamping ring 24 may also utilize the same plurality of circumferentially spaced ring scallops 32 formed radially into the inner ring circumference as shown in FIG. 10. Circumferentially spaced based ring scallops 32 of improved tire bead sealing ring 24 are secured to circumferentially spaced base scallops 34 of improved tire bead mounting flange 22 in such a manner that the rings scallops and base scallops are aligned. Fastener receiving holes 18 are positioned at the points of the scallops as shown in FIG. 10. This scallop configuration may increase the clamping forces of the sandwiched structure and reduce assist in the more even clamping along tire bead clamping ring 24. It should be noted that circumferentially spaced base scallops 34 and circumferentially spaced ring scallops 32 may be utilized with conventional tire bead mounting flange 16 and conventional tire bead clamping ring 16.

It is to be understood that while certain forms of the apparatus for securing a tire to a wheel have been illustrated and described herein, it is not to be limited to the specific forms or arrangement of parts described and shown.

Having thus described the invention what is claimed as new and desired to be secured by Letters Patent is as follows:

1. A tire bead clamping structure for securing a tire with a tire bead on a wheel having a wheel axis and a circumferential tire bead mounting flange and comprising:
(a) a circumferential protrusion extending axially outward from said tire bead mounting flange; and
(b) a tire bead clamping ring removably secured to said wheel to sealingly and grippingly clamp said tire bead between said tire bead mounting flange and said tire bead clamping ring.

2. The structure as claimed in claim 1 wherein:
(a) a surface of said tire bead mounting flange is substantially parallel to an opposing surface of said tire bead clamping ring.

3. The structure as claimed in claim 1 wherein:
(a) said tire bead mounting flange has a flange surface; and
(b) said circumferential protrusion includes a circumferential sealing bead extending circumferentially along said flange surface.

4. The structure as claimed in claim 1 wherein:
(a) said tire bead mounting flange has a flange surface; and
(b) said circumferential protrusion includes a circumferential bead lock wedge extending circumferentially along said flange surface.

5. The structure as claimed in claim 1 wherein said tire bead mounting flange has a flange surface, and including:
(a) said circumferential protrusion including a circumferential sealing bead extending circumferentially along said flange surface; and
(b) said circumferential protrusion further including a circumferential bead lock wedge extending circumferentially along said flange surface.

6. The structure as claimed in claim 1 wherein:
(a) a surface of said tire bead mounting flange is angled at an acute angle relative to said wheel axis.

7. The structure as claimed in claim 1 wherein:
(a) a surface of said tire bead mounting flange is angled at about 20 to 70 degrees relative said wheel axis.

8. The structure as claimed in claim 1 wherein:
(a) said tire bead mounting flange includes a circumferential bead relief groove extending axially inwardly of said wheel and positioned radially inwardly of said circumferential protrusion.

9. A tire bead clamping structure for securing a tire with a tire bead on a wheel having a wheel axis and a circumferential bead lock base with an inner bead lock circumference and a circumferential tire bead mounting flange extending radially outward from said bead lock base, and said structure comprising:
(a) said circumferential bead lock base having a plurality of circumferentially spaced base scallops formed radially into said inner bead lock base circumference; and
(b) a tire bead clamping ring removably secured to said wheel to sealingly and grippingly clamp said tire bead between said tire bead mounting flange and said tire bead clamping ring.

10. The structure as claimed in claim 9 and including:
(a) said tire bead clamping ring having an inner ring circumference;
(b) said tire bead clamping ring having a plurality of circumferentially spaced ring scallops formed radially into said inner ring circumference, said ring scallops being shaped similar to said base scallops; and
(c) said ring being secured to said wheel in such a manner as to align said ring scallops of said ring with said base scallops of said wheel.

11. The structure as claimed in claim 9 and including:
(a) said tire bead mounting flange has a flange surface; and
(b) said tire bead mounting flange including a circumferential protrusion extending axially outwardly from said flange surface.

12. The structure as claimed in claim 11 wherein:
(a) said circumferential protrusion includes a circumferential sealing bead extending circumferentially along said flange surface.

13. The structure as claimed in claim 11 wherein:
(a) said circumferential protrusion includes a circumferential bead lock wedge extending circumferentially along said flange surface.

14. The structure as claimed in claim 11 and including:
(a) said circumferential protrusion including a circumferential sealing bead extending circumferentially along said flange surface; and
(b) said circumferential protrusion further including a circumferential bead lock wedge extending circumferentially along said flange surface.

15. The structure as claimed in claim 11 wherein:
(a) said flange surface is angled at an acute angle relative to said wheel axis.

16. The structure as claimed in claim 11 wherein:
(a) said flange surface is angled at about 20 to 70 degrees relative to said wheel axis.

17. The structure as claimed in claim 11 wherein:
(a) said tire bead mounting flange includes a circumferential bead relief groove extending axially inwardly of said wheel and positioned radially inwardly of said circumferential protrusion.

18. A tire bead clamping structure for securing a tire with a tire bead on a wheel having a wheel axis and a circumferential bead lock base with an inner bead lock circumference and a circumferential tire bead mounting flange extending radially outward from said bead lock base, and said structure comprising:
(a) said circumferential tire bead mounting flange including a flange surface angled at an acute angle relative to said wheel axis;
(b) a circumferential sealing bead extends axially outwardly from said flange surface and circumferentially along said flange surface;
(c) a circumferential bead relief groove extends axially inwardly from said wheel into said flange surface radially inwardly of said sealing bead;
(d) said circumferential bead lock base having a plurality of circumferentially spaced base scallops formed radially into said inner bead lock circumference; and
(e) a tire bead clamping ring removably secured to said wheel to sealingly and grippingly clamp said tire bead between said bead mounting flange and said tire bead clamping ring.

19. The structure as claimed in claim 18 and including:
(a) said tire bead clamping ring having an inner ring circumference;
(b) said tire bead clamping ring having a plurality of circumferentially spaced ring scallops formed radially into said inner ring circumference, said ring scallops being shaped similar to said base scallops; and
(c) said ring being secured to said wheel in such a manner as to align said ring scallops of said ring with said base scallops of said wheel.

20. The structure as claimed in claim 18 wherein:
(a) said flange surface is angled at about 20 to 70 degrees relative to said wheel axis.
